(19) United States
(12) Patent Application Publication
(10) Pub. No.: US 2025/0046930 A1
(43) Pub. Date: Feb. 6, 2025

(54) COMPARTMENT FOR A DEVICE LIABLE TO GIVE OFF HEAT

(71) Applicant: VALEO SYSTEMES THERMIQUES, Le Mesnil-Saint-Denis (FR)

(72) Inventors: Guillaume Gardere, Le Mesnil-Saint-Denis Cedex (FR); Sergio Da Costa Pito, Le Mesnil-Saint-Denis Cedex (FR); Nicolas Levasseur, Le Mesnil Saint Denis Cedex (FR)

(73) Assignee: VALEO SYSTEMES THERMIQUES, Le Mesnil-Saint-Denis (FR)

(21) Appl. No.: 18/718,739

(22) PCT Filed: Oct. 4, 2022
(86) PCT No.: PCT/EP2022/077576

§ 371 Date: Jun. 11, 2024

(30) Foreign Application Priority Data
Dec. 16, 2021 (FR) 2113739

(51) Int. Cl. H01M 50/229; H01M 50/249; H01M 50/276

(52) U.S. Cl. CPC H01M 50/229; H01M 50/249; H01M 50/276

(57) ABSTRACT

A compartment for a device liable to give off heat during operation is disclosed. The device is an electrical energy storage device for a vehicle. The compartment includes at least one seat arranged to receive the electrical device, at least one beam forming a side wall of the seat, and a cover arranged to be assembled with the beam to close the seat. The beam in the compartment includes a core made of a composite material containing a plastics material and reinforcing elements. Either the beam or the cover includes at least one metal element. The compartment also includes at least one metal claw arranged to come into contact with the metal element and to penetrate the material bearing the metal element. The metal element is electrically continuous with the metal claw to participate in an electromagnetic protection of the component.

The present invention relates to a compartment for a device liable to give off heat during operation, notably for an electrical energy storage device for a motor vehicle.

Patent applications US2017/176108 and WO 2013056938 describe heat exchangers for cooling battery cells. Furthermore, patent application US 2011/0206967 A describes an example of such a battery. In that application, the cells are stored in containers having housings for receiving the cells. A wall of the containers, intended to be in contact with a wall of a neighboring container, has depressions forming part of a duct for circulating a heat transfer fluid.

It is advantageous to use plastic-based composite materials to make these compartments. This type of material is more lightweight and may have suitable mechanical properties.

The battery is generally subject to electromagnetic stresses originating from the various electronic devices on the vehicle, such as the electronic control unit (ECU), which can cause interference and the malfunctioning of the battery, known as electromagnetic interference (EMI).

The invention is intended to overcome this drawback.

The present invention therefore relates to a compartment for a device liable to give off heat during operation, the device notably being an electrical energy storage device for a vehicle, this compartment including at least one seat arranged to receive said electrical device, at least one beam forming a side wall of this seat, and a cover arranged to be assembled with the beam to close the seat, the beam in the compartment comprising a core made of a composite material containing a plastics material and reinforcing elements, for example glass fibers or carbon fibers, either this beam or the cover comprising at least one metal element, the compartment further comprising at least one metal claw arranged to come into contact with said metal element and to penetrate the material bearing this metal element, this metal element being electrically continuous with the metal claw so as to participate in an electromagnetic protection of the compartment.

The invention makes it possible to have a compartment with a structure made globally of composite material that nonetheless provides protection against electromagnetic interference and guarantees electrical continuity (EMC).

The metal elements on the cover and the beam or beams, in addition to protecting against electromagnetic interference and ensuring electrical continuity, may also provide fire resistance, thereby improving overall safety.

The metal claw or claws help to make electrical continuity more reliable because this or these metal claws remain in contact with the metal element to be electrically coupled.

According to one of the aspects of the invention, the metal element is at least partially embedded in the material bearing said metal element.

According to one of the aspects of the invention, the metal element, for example a metal sheet, is entirely embedded in the material, for example in the plastics material of the beam.

According to one of the aspects of the invention, the metal claw penetrates the plastics material in which the metal element is embedded.

According to one of the aspects of the invention, the metal element includes one of the following elements: a metal sheet, a metal woven material, a metal coating, loosely arranged metal fibers or threads.

According to one of the aspects of the invention, the metal element includes aluminum.

According to one of the aspects of the invention, the beam and the cover each include a metal element.

According to one of the aspects of the invention, the metal element of the beam is embedded in the material of the beam and the metal element of the cover is embedded in the material of the cover.

In this case, the metal claw makes the electrical connection between the two embedded metal elements.

According to one of the aspects of the invention, the metal claw belongs to the cover, which comprises a metal element, for example a metal sheet, and the metal claw is in electrical contact with this metal element.

According to one of the aspects of the invention, the metal claw or claws of the cover may for example be fastened to the cover by being overmolded in the material of the cover.

In a variant, the metal claw belongs to the beam, which comprises a metal element, for example a metal sheet, and the metal claw is in electrical contact with this metal element.

In another variant, the metal claw belongs to an anti-creep ring interposed between the cover and the beam or beams.

According to one of the aspects of the invention, the anti-creep ring is electrically conductive.

According to one of the aspects of the invention, the anti-creep ring includes a plurality of metal claws distributed about the perimeter thereof.

According to one of the aspects of the invention, the metal claw has a tip that can penetrate a plastics material.

A plurality of metal claws arranged to penetrate the material and to come into contact with the metal element is preferably provided.

According to one of the aspects of the invention, the compartment includes one or more screws for screwing the cover to the beam or beams.

Screwing the cover to the beams makes it possible to bear against the metal claws penetrating the material of the beams.

According to one of the aspects of the invention, the anti-creep ring is in front of the screw so that the screw shaft passes through the anti-creep ring.

The present invention also relates to a compartment for a device liable to give off heat during operation, the device notably being an electrical energy storage device for a vehicle, this compartment including at least one seat arranged to receive said electrical device, at least one beam forming a side wall of this seat, and a cover arranged to be assembled with the beam to close the seat, the compartment being characterized in that the beam comprises a core made of a composite material containing a plastics material and reinforcing elements, for example glass fibers or carbon fibers, this beam and the cover each comprising at least one metal element, these metal elements being electrically continuous with one another so as to participate in an electromagnetic protection of the compartment.

According to one of the aspects of the invention, the metal element includes one of the following elements: a metal sheet, a metal woven material, a metal coating, loosely arranged metal fibers or threads.

According to one of the aspects of the invention, the metal element includes aluminum.

According to one of the aspects of the invention, the face of the beam forming the side wall is entirely covered by the metal element, which is notably a metal sheet, a metal woven material, a metal coating, metal fibers or threads loosely arranged on this face of the beam.

In a variant, a zone or some zones of this face of the beam have no metal elements.

According to one of the aspects of the invention, the metal element of the beam is on the surface of the beam. In this case, the metal element is notably connected to the composite material of the beam, on the surface thereof.

For example, where the metal element is a metal coating, this coating can be deposited on a face of the composite material of the beam.

Where the metal element is a metal woven material or sheet, this sheet or this woven material may be connected to the composite material during manufacture of the beam.

According to one of the aspects of the invention, the beam is formed by pultrusion, i.e. extrusion by pulling, of the composite material.

According to one of the aspects of the invention, the composite material includes continuous glass or carbon fibers providing mechanical reinforcement.

According to one of the aspects of the invention, the pultrusion is carried out in the direction of these continuous fibers.

According to one of the aspects of the invention, the plastic matrix of the composite material is a thermoplastic or a thermosetting material.

According to one of the aspects of the invention, the plastic matrix is selected from the following: a polyolefin, a polyamide, a polyester, a polyurethane, an acrylic.

For example, the matrix is a thermosetting material. The matrix notably contains vinyl ester, epoxy, or an epoxy/vinyl ester mixture.

According to one of the aspects of the invention, the beam is hollow in the longitudinal direction.

According to one of the aspects of the invention, each beam comprises one or more cavities resulting from pultrusion.

According to one of the aspects of the invention, these cavities are parallel with one another.

According to one of the aspects of the invention, these cavities are arranged on top of one another in the vertical direction of the seat.

According to one of the aspects of the invention, the metal element is at least partially embedded in the composite material of the beam.

According to one of the aspects of the invention, the cover is made of a plastics material.

According to one of the aspects of the invention, the cover is made of a composite material containing a plastics material and reinforcing elements, for example glass fibers or carbon fibers.

The cover and the beam may be made of the same material, if desired.

According to one of the aspects of the invention, the cover is arranged to bear against the beams forming the side wall of the seat.

According to one of the aspects of the invention, the metal element entirely covers a face of the cover oriented toward the seat.

For example, where the metal element is a metal woven material or sheet, this sheet or this woven material extends over the entirety of this face of the cover oriented toward the seat.

According to one of the aspects of the invention, the cover includes a rim bearing against an edge face of the beams.

According to one of the aspects of the invention, the cover has a flat face bordered by this peripheral rim.

According to one of the aspects of the invention, the metal element of the cover and the metal element of the beam or beams are electrically continuous via an electric contact between these metal elements.

According to one of the aspects of the invention, the metal element of the beam extends over the face forming the side wall and over at least one of the edge faces of the beam.

According to one of the aspects of the invention, the metal element of the cover extends over a rim of this cover and comes into contact with the metal element of the beam, on the edge face of this beam.

According to one of the aspects of the invention, this contact thus provides electrical continuity.

For example, where the metal elements are metal woven materials or sheets, these sheets or these woven materials come into contact with one another.

According to one of the aspects of the invention, the compartment includes a cooling plate comprising one or more channels intended to convey a coolant fluid.

According to one of the aspects of the invention, the plate is made of a metal material, for example aluminum.

According to one of the aspects of the invention, the cooling plate is arranged in a bottom of the seat of the compartment so that the electrical device to be cooled rests on this plate, or these plates if the compartment contains several plates.

According to one of the aspects of the invention, the metal element of the beam or beams is electrically continuous with the cooling plate or plates, which are made of metal.

This provides a protective cage against electromagnetic interference. For example, this cage entirely envelops the electrical devices seated in the compartment.

According to one of the aspects of the invention, the beam or beams comprise edge faces where the metal element is present and that rest on the cooling plate or plates so as to provide electrical continuity between the side wall of the beams and the cooling plates.

According to one of the aspects of the invention, the compartment includes a bottom cover.

According to one of the aspects of the invention, the cooling plate or plates rest on this bottom cover.

According to one of the aspects of the invention, this bottom cover is made of a plastic-based composite material.

According to one of the aspects of the invention, the side wall of the compartment is formed by four substantially rectangular faces.

The invention also relates to an electrical energy storage module having a plurality of battery cells that are notably disposed in a row, and a compartment as described above, the cells being placed in this compartment in thermal interaction with the cooling plate.

By virtue of the invention, this module performs an electromagnetic protection function (also referred to as electromagnetic compatibility or ECM).

Other features, details and advantages of the invention will become more clearly apparent on reading the detailed description provided below, and in addition from multiple example embodiments provided by way of indication and without limitation with reference to the attached schematic drawings, in which:

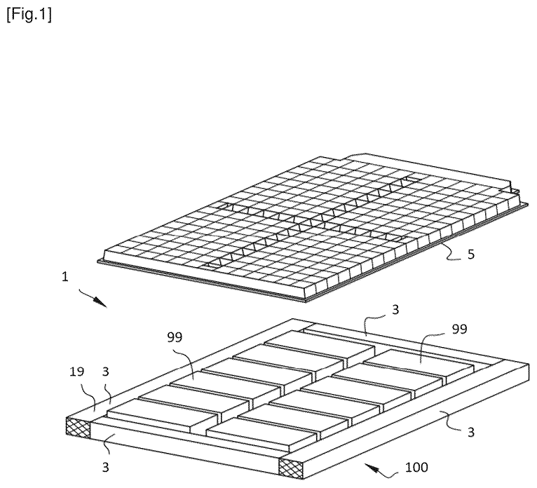

FIG. 1 is a schematic perspective view of a compartment according to one example embodiment of the invention,

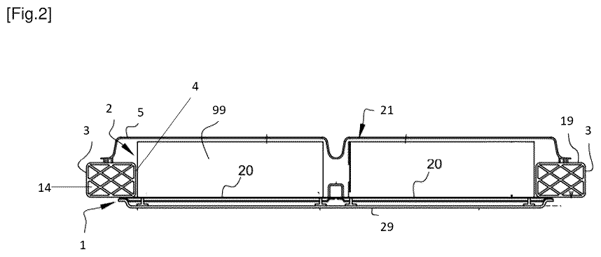

FIG. 2 shows the compartment of [FIG. 1] in cross section,

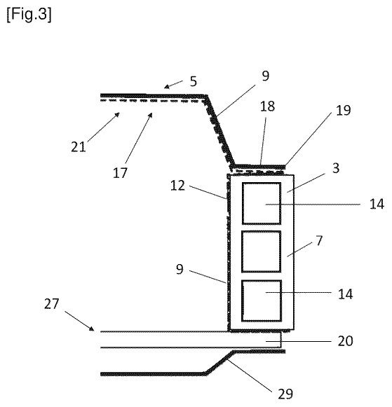

FIG. 3 is a detailed schematic view of the compartment in [FIG. 1],

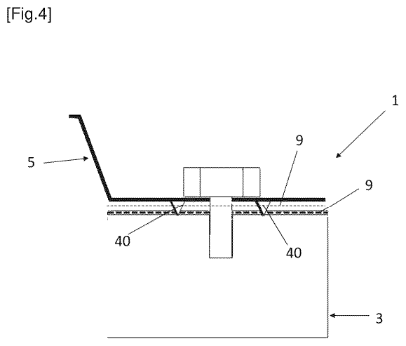

FIG. 4 is a partial schematic view of a compartment according to another example embodiment of the invention,

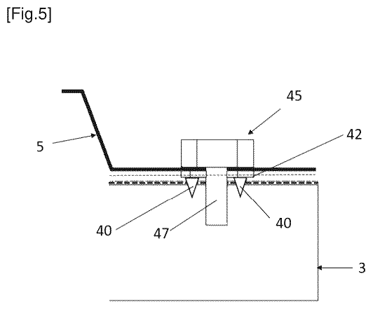

FIG. 5 is a partial schematic view of a compartment according to yet another example embodiment of the invention.

FIGS. 1 and 2 show an electrical energy storage module 100 having a plurality of battery cells 99 and a compartment 1.

This compartment 1 includes a seat 2 arranged to receive the electrical devices, and in this case four beams 3 forming the side wall 4 of this seat 2.

The compartment 1 further comprises a cover 5 arranged to be assembled with the beams 3 to close the seat 2.

As shown in FIG. 3, each beam 3 comprises a core 7 made of composite material containing a plastics material and reinforcing elements, in this case glass fibers or carbon fibers.

The beams 3 and the cover 5 each comprise a metal element 9, these metal elements 9 being electrically continuous with one another so as to participate in an electromagnetic protection of the compartment 1.

The metal element 9 includes one of the following elements: a metal sheet, a metal woven material, a metal coating, loosely arranged metal fibers or threads.

Each metal element 9 is made from aluminum, for the threads or fibers.

The face 12 of the beam 3 forming the side wall 4 is entirely covered by the metal element 9, which is here a metal sheet, a metal woven material, a metal coating, metal fibers or threads loosely arranged on this face 12 of the beam 3.

The side wall 4 of the compartment is formed by four substantially rectangular faces.

The metal element 9 of each beam 3 is on the surface of the beam. In this case, the metal element is connected to the composite material of the beam 3.

For example, where the metal element is a metal coating, this coating can be deposited on a face of the composite material of the beam 3.

Where the metal element 9 is a metal woven material or sheet, this sheet or this woven material may be connected to the composite material during manufacture of the beam 3.

Each beam 3 is formed by pultrusion, i.e. extrusion by pulling, of the composite material.

The composite material includes continuous glass or carbon fibers providing mechanical reinforcement. The pultrusion is carried out in the direction of these continuous fibers. The plastic matrix of the composite material is a thermoplastic or a thermosetting material. The plastic matrix is selected from the following: a polyolefin, a polyamide, a polyester.

Each beam 3 is hollow in the longitudinal direction of the beam in question, and comprises several cavities 14 resulting from the pultrusion. These cavities 14 are parallel with one another.

These cavities 14 are arranged on top of one another in the vertical direction of the seat.

The cover 5 is made of a composite material containing a plastics material and reinforcing elements, for example glass fibers or carbon fibers.

The cover 5 is arranged to bear against the beams 3 forming the side wall of the seat.

The metal element 9 entirely covers a face 17 of the cover 5 oriented toward the seat 2.

For example, where the metal element 9 is a metal woven material or sheet, this sheet or this woven material 9 extends over the entirety of this face 17 of the cover 5.

The cover 5 includes a rim 18 bearing against an edge face 19 of the beams 3.

The cover 5 has a flat face 21 bordered by this peripheral rim 18.

The metal element 9 of the cover 5 and the metal element 9 of the beams 3 are electrically continuous via an electric contact between these metal elements 9.

The metal element 9 of each beam 3 extends over the face 12 forming the side wall and the edge face 19 of the beam that is in front of the cover 5.

The metal element 9 of the cover 5 extends over a rim 18 of this cover 5 and comes into contact with the metal element 9 of the beams 3, on the edge face 19 of these beams 3.

This contact thus ensures electrical continuity.

For example, where the metal elements 9 are metal woven materials or sheets, these sheets or these woven materials come into contact with one another.

The compartment includes cooling plates 20 comprising one or more channels intended to convey a coolant fluid.

Each plate 20 is made of a metal material, for example aluminum.

The cooling plates 20 are disposed in a bottom 27 of the seat 2 of the compartment 1 such that the battery cells 99 rest on these plates 20.

The metal element 9 of the beams 3 is electrically continuous with the cooling plates 20, which are made of metal.

This provides a protective cage against electromagnetic interference.

The compartment 1 includes a bottom cover 29.

The cooling plates 20 rest on this bottom cover 29, for example via ribs.

This bottom cover 29 is made of a plastic-based composite material.

The coolant liquid circulating in the cooling plates 20 may notably be a liquid refrigerant based on carbon dioxide, such as R744 for example, 2,3,3,3-tetrafluoropropene (or HFO-1234yf) or 1,1,1,2-tetrafluoroethane (or R-134a). The coolant liquid may also be a nanofluid. The coolant liquid may also be water, possibly including additives.

The cooling plates 20 form a heat exchanger included in a cooling circuit (not shown) comprising a compressor and other heat exchangers.

The battery cells 99 comprise for example a plurality of lithium-ion (Li-ion) batteries for use in a hybrid vehicle. In another embodiment, the plurality of battery cells are Li-ion batteries for use in a battery-powered electric vehicle.

Another example embodiment of the invention is described with reference to FIG. 4.

In this embodiment, the cover 5 comprises metal claws 40 arranged to come in contact with the metal element 9 of the beam 3 and to penetrate the material bearing this metal element 9.

This metal element 9 is thus electrically continuous with the metal claws 40 so as to participate in an electromagnetic protection of the compartment 1.

The metal element 9 of the beam 3 is entirely embedded in the plastics material of the beam.

Each metal claw 40 penetrates the plastics material in which the metal element is embedded, in this case the material of the beam 3.

The metal element 9 includes one of the following elements: a metal sheet, a metal woven material, a metal coating, loosely arranged metal fibers or threads.

The beam 3 and the cover 5 each include a metal element 9.

The metal element 9 of the beam is embedded in the material of the beam 3 and the metal element 9 of the cover 5 is on the surface of the cover 5.

In this case, the metal claws 40 make the electrical connection between the two metal elements 9.

The metal claws 40 belong to the cover 5, which itself comprises a metal element 9, for example a metal sheet, and the metal claws 40 are in electrical contact with this metal element 9.

The metal claws 40 of the cover 5 may for example be fastened to the cover 5 by being overmolded in the material of the cover.

In a variant, the metal claws 40 belong to the beam 4, which comprises a metal element, for example a metal sheet, and the metal claws are in electrical contact with this metal element.

In another variant, as shown in FIG. 5, the metal claws 40 belong to an anti-creep ring 42 interposed between the cover 5 and the beams 3.

The anti-creep ring 42 is electrically conductive.

The anti-creep ring 42 includes a plurality of metal claws 40 distributed about the perimeter thereof.

Each metal claw 40 has a tip 44 that can penetrate a plastics material.

A plurality of metal claws 40 arranged to penetrate the material and to come into contact with the metal element 9 is provided.

The compartment 1 includes one or more screws 45 for screwing the cover 5 to the beams 3.

Screwing the cover 5 to the beams 3 makes it possible to bear against the metal claws 40 penetrating the material of the beams.

The anti-creep ring 42 is in front of the screw 45 so that the screw shaft 47 passes through the anti-creep ring 42.

1. A compartment for a device liable to give off heat during operation, wherein the device is an electrical energy storage device for a vehicle, the compartment comprising:
at least one seat arranged to receive the electrical device;
at least one beam forming a side wall of the seat;
a cover arranged to be assembled with the beam to close the seat,
the beam in the compartment comprising a core made of a composite material containing a plastics material and reinforcing elements, such as glass fibers or carbon fibers,
wherein either the beam or the cover comprise at least one metal element; and
at least one metal claw arranged to come into contact with the metal element and to penetrate the material bearing the metal element,
wherein the metal element is electrically continuous with the metal claw so as to participate in an electromagnetic protection of the compartment.

2. The compartment as claimed in claim 1,
wherein the metal element is at least partially embedded in the material bearing the metal element.

3. The compartment as claimed in claim 2,
wherein the metal claw penetrates the plastics material in which the metal element is embedded.

4. The compartment as claimed in claim 1,
wherein the metal element comprises one of the following elements: a metal sheet, a metal woven material, a metal coating, loosely arranged metal fibers or metal threads.

5. The compartment as claimed in claim 1,
wherein the beam and the cover each include a metal element.

6. The compartment as claimed in claim 1,
wherein the metal claw corresponds to the cover, which comprises a metal element, and
wherein the metal claw is in electrical contact with the metal element.

7. The compartment as claimed in claim 1,
wherein the metal claw corresponds to an anti-creep ring interposed between the cover and the beam.

8. The compartment as claimed in claim 7,
wherein the anti-creep ring includes a plurality of metal claws distributed about the perimeter thereof.

9. The compartment as claimed in claim 1,
wherein the metal claw comprises a tip that is able to penetrate a plastic material.

10. The compartment as claimed in claim 1,
wherein the compartment comprises one or more screws for screwing the cover to the beam.
